(19) United States
(12) Patent Application Publication
(10) Pub. No.: US 2011/0068733 A1
(43) Pub. Date: Mar. 24, 2011

(54) Electronic vampire

(76) Inventor: Paul Duda, Columbus, OH (US)

(21) Appl. No.: 12/069,584

(22) Filed: Feb. 11, 2008

Related U.S. Application Data
(63) Continuation of application No. 11/986,279, now abandoned.

(51) Int. Cl. H02J 7/00

(52) U.S. Cl. 320/107

(57) ABSTRACT

Even though this patent shows relays being used it is not intended to be this way. Any electronic switch can be used, also, the same is true for the AC/DC (Alternating Current to Direct Current) converter.

This idea is comprised of the following: 100 Plug in to power source, 101 relay, 102 transformer, 103 primary of transformer, 104 secondary of transformer, 500 any AC to DC converter, 200 charger, 201 any switch or continuity connector that is activated when item being charged is plugged in, 202 power connections to item being charged, 300 cable, 301 & 302 completes circuit in primary, 303 & 304 supply power to item being charged.

### BACKGROUND ON THE INVENTION

### Field of Invention

In reading TIME MAGAZINE it was discovered that all charging devices are left plugged in to the outlet even when nothing is being charged. They went on to say this uses about 1% of all electricity and will probably continue to rise as more items are being thought of that require being charged. The invention can be used in other systems using transformers.

### OBJECT AND ADVANTAGE

The object here is to keep the plug in module from using electricity when nothing on the secondary circuit is being charged or used.

### SUMMARY

There are two additional wires in the cable, 301 & 302 ,that activate the primary source, 103, and keep it active as long as something is plugged in the charging unit (charger), 200.

### BRIEF DESCRIPTION OF DRAWINGS

FIG. 1 Typical charging unit (do not mean only this kind).

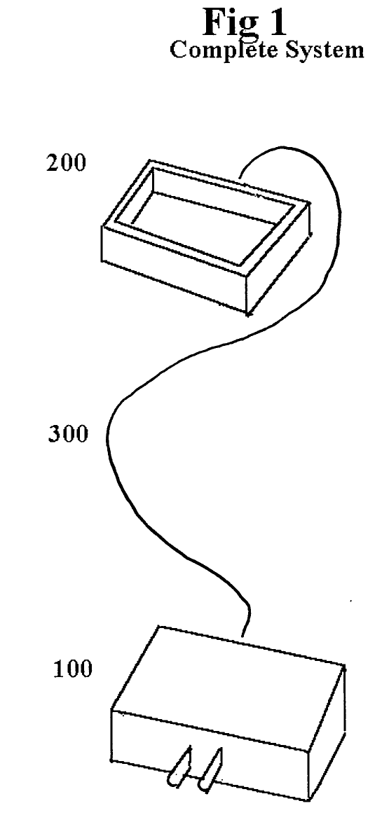

FIG. 2 Schematic of plug in device 100.

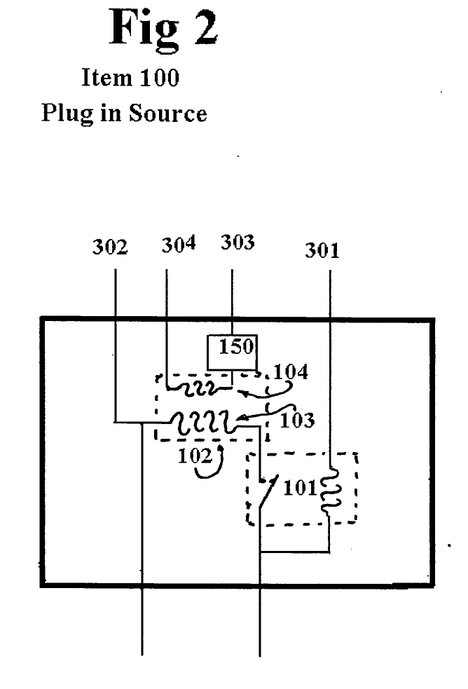

FIG. 3 Schematic of charging unit 200.

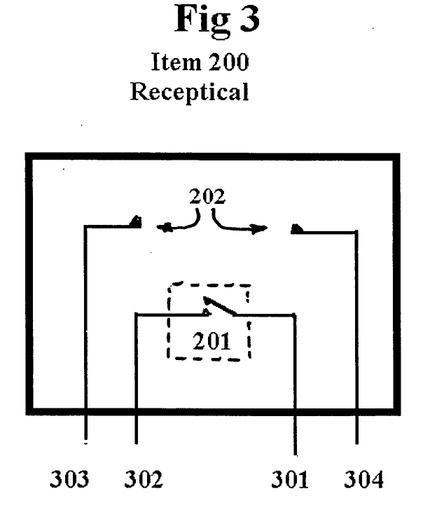

FIG. 4 Connecting cable 300.

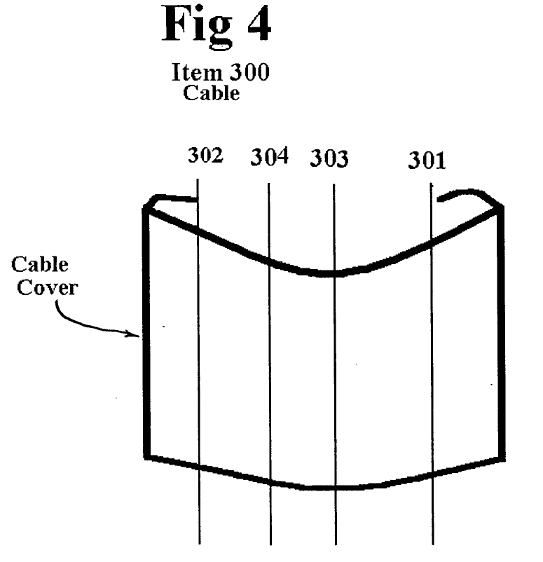

### REFERENCE NUMBERS IN DRAWING

The table below lists the reference numbers in the figures.
100 Plug in source.
101 Relay (or any electronic device serving the same purpose).
102 Transformer
103 Primary of transformer.
104 Secondary of transformer.
150 AC/DC Converter (Alternating Current to Direct Current)
200 Charging receptacle for unit being charged.
201 Any switch that is activated when unit being charged is plugged in.
202 Contact points to item being charged.
300 Cable.
301 Circuit being used to activate primary.
302 Completing the circuit to activate the primary.
303 Supplies power to item being charged.
304 Completing the circuit for the item being charged.

### DETAILED DESCRIPTION

The objective is to cut off power to the primary circuit 100. This is accomplished by controlling the primary circuit from the secondary (Charger 200). The secondary has control via the switch 201, in the charger 200. The switch closes the circuit of 301 & 302. When relay 101 is activated then the primary 103 is activated producing power to the secondary 104. The AC power generated in the secondary is then converted by the AC/DC converter 150 thus supplying power to the unit being charged via wires 303 at 304.

I claim:

1. A device for reducing power consumption comprising:
a transformer operable to engage a power source;
a switch in the charging unit that is actuated by the item being charged,
a relay in the plug in source unit that when activated completes the primary circuit,
an AC to DC converter operatively connected to the secondary of the transformer;
a pair of cables connecting the plug in source to the charger unit that supplies DC to the unit being charged.

2. Any switching device that can replace the relay in claim 1.

3. This idea can be used in any system that uses a transformer when the power being used by the secondary is not needed.
